(19) United States
(12) Patent Application Publication
(10) Pub. No.: US 2014/0349612 A1
(43) Pub. Date: Nov. 27, 2014

(54) METHOD, APPARATUS AND SYSTEM OF MANAGING A USER LOGIN INTERFACE

(71) Applicants: Jian Zhao, Shanghai (CN); Xiantao Zhang, Shanghai (CN)

(72) Inventors: Jian Zhao, Shanghai (CN); Xiantao Zhang, Shanghai (CN)

(21) Appl. No.: 13/997,769

(22) PCT Filed: Oct. 4, 2012
(86) PCT No.: PCT/CN2012/082527

§ 371 Date: Jun. 25, 2013

(51) Int. Cl. H04W 12/08; G06F 3/0488; G06F 3/0484; H04M 1/725

(52) U.S. Cl. CPC H04W 12/08; H04M 1/72577; G06F 3/0488; G06F 3/04842
USPC 455/411

(57) ABSTRACT

A device, method and system for recovering an operating system may comprise a login input part movement control module to determine at least one factor related to a movement of a login input part from a position for a previous user login to a position for a new user login; a login input part movement module to move the login input part based on the at least one factor; and a display module to display the login input part after the movement for the new user login.

### BACKGROUND

With prevailing of mobile communication devices, such as smart phones and tablets, security has attracted more and more attention. In order to enhance the security, a user login may be required in several situations, such as booting the mobile communication device, unlocking the mobile communication device, running an application program and/or others. Currently, the user login may be implemented in several ways. For example, a user may input a password (numbers, alphabets or symbols) on a user login interface displayed on a touch screen of the mobile communication device.

However, since the password input may leave a finger trace on the touch screen, the password may be stolen through detecting the finger trace, which may cause an unauthorized access of the mobile communication device by other people.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates an embodiment of a mobile communication device.

FIG. 2 illustrates an embodiment of an environment for managing a user login interface, which is established by the mobile communication device.

FIG. 3a-3b illustrate an embodiment of the user login interface.

FIG. 4a-4b illustrate another embodiment of the user login interface.

FIG. 5 illustrates an embodiment of a method of managing the user login interface.

### DETAILED DESCRIPTION

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present disclosure. It will be appreciated, however, by one skilled in the art that embodiments of the disclosure may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention implemented in a computer system may include one or more bus-based interconnects between components and/or one or more point-to-point interconnects between components. Embodiments of the invention may also be implemented as instructions carried by or stored on a transitory or non-transitory machine-readable (e.g., computer-readable) medium, which may be read and executed by one or more processors. A machine-readable medium may be embodied as any device, mechanism, or physical structure for storing or transmitting information in a form readable by a machine (e.g., a computing device). For example, a machine-readable medium may be embodied as read only memory (ROM); random access memory (RAM); magnetic disk storage media; optical storage media; flash memory devices; mini- or micro-SD cards, memory sticks, electrical signals, and others.

In the drawings, specific arrangements or orderings of schematic elements, such as those representing devices, modules, instruction blocks, and data elements, may be shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in some embodiments.

In general, schematic elements used to represent instruction blocks may be implemented using any suitable form of machine-readable instruction, such as software or firmware applications, programs, functions, modules, routines, processes, procedures, plug-ins, applets, widgets, code fragments and/or others, and that each such instruction may be implemented using any suitable programming language, library, application programming interface (API), and/or other software development tools. For example, some embodiments may be implemented using Java, C++, and/or other programming languages. Similarly, schematic elements used to represent data or information may be implemented using any suitable electronic arrangement or structure, such as a register, data store, table, record, array, index, hash, map, tree, list, graph, file (of any file type), folder, directory, database, and/or others.

Further, in the drawings, where connecting elements, such as solid or dashed lines or arrows, are used to illustrate a connection, relationship or association between or among two or more other schematic elements, the absence of any such connecting elements is not meant to imply that no connection, relationship or association can exist. In other words, some connections, relationships or associations between elements may not be shown in the drawings so as not to obscure the disclosure. In addition, for ease of illustration, a single connecting element may be used to represent multiple connections, relationships or associations between elements. For example, where a connecting element represents a communication of signals, data or instructions, it should be understood by those skilled in the art that such element may represent one or multiple signal paths (e.g., a bus), as may be needed, to effect the communication.

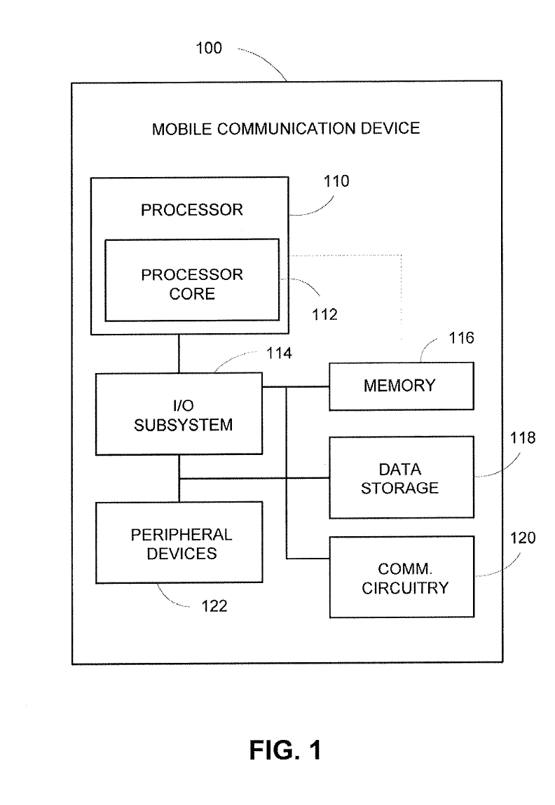

FIG. 1 illustrates an embodiment of a mobile communication device 100. The mobile communication device 100 may be embodied as, without limitation, a smart phone, a cellular telephone, a tablet, a consumer electronic device, a laptop computer, a notebook computer, a desktop computer, a mobile computing system, a work station, a network appliance, a web appliance, a distributed computing system, a multiprocessor system, a processor-based system, and/or any other mobile communication device configured to manage the user login interface, in order to enhance security of the mobile communication device.

In an embodiment, the mobile communication device 100 may include a processor 110, an I/O subsystem 114, a memory 116, a data storage 118, a communication circuitry 120, and one or more peripheral devices 122. In some embodiments, several of the foregoing components may be incorporated on a motherboard or main board of the mobile communication device 100, while other components may be communicatively coupled to the motherboard via, for example, a peripheral port. Furthermore, it should be appreciated that the mobile communication device 100 may include other components, sub-components, and devices commonly found in a communication and/or computing device, which are not illustrated in FIG. 1 for clarity of the description.

The processor 110 of the mobile communication device 100 may be embodied as any type of processor capable of executing software/firmware, such as a microprocessor, digital signal processor, microcontroller, or the like. The processor 110 is illustratively embodied as a single core processor having a processor core 112. However, in other embodiments, the processor 110 may be embodied as a multi-core processor having multiple processor cores 112. Additionally, the mobile communication device 100 may include additional processors 110 having one or more processor cores 112.

The I/O subsystem 114 of the mobile communication device 100 may be embodied as circuitry and/or components to facilitate input/output operations with the processor 110 and/or other components of the mobile communication device 100. In some embodiments, the I/O subsystem 114 may be embodied as a memory controller hub (MCH or “northbridge”), an input/output controller hub (ICH or “southbridge”) or platform controller hub (PCH), and a firmware device. In such embodiments, the firmware device of the I/O subsystem 114 may be embodied as a memory device for storing Basic Input/Output System (BIOS) data and/or instructions and/or other information (e.g., a BIOS driver used during booting of the mobile communication device 100). However, in other embodiments, I/O subsystems having other configurations may be used. For example, in some embodiments, the I/O subsystem 114 may be embodied as a platform controller hub (PCH). In such embodiments, the memory controller hub (MCH) may be incorporated in or otherwise associated with the processor 110, and the processor 110 may communicate directly with the memory 116 (as shown by the dashed line in FIG. 1). Additionally, in other embodiments, the I/O subsystem 114 may form a portion of a system-on-a-chip (SoC) and be incorporated, along with the processor 110 and other components of the mobile communication device 100, on a single integrated circuit chip.

The processor 110 is communicatively coupled to the I/O subsystem 114 via a number of signal paths. These signal paths (and other signal paths illustrated in FIG. 1) may be embodied as any type of signal paths capable of facilitating communication between the components of the mobile communication device 100. For example, the signal paths may be embodied as any number of point-to-point links, wires, cables, light guides, printed circuit board traces, vias, bus, intervening devices, and/or the like.

The memory 116 of the mobile communication device 100 may be embodied as or otherwise include one or more memory devices or data storage locations including, for example, dynamic random access memory devices (DRAM), synchronous dynamic random access memory devices (SDRAM), double-data rate synchronous dynamic random access memory device (DDR SDRAM), mask read-only memory (ROM) devices, erasable programmable ROM (EPROM), electrically erasable programmable ROM (EEPROM) devices, flash memory devices, and/or other volatile and/or non-volatile memory devices. The memory 116 is communicatively coupled to the I/O subsystem 114 via a number of signal paths. Although only a single memory device 116 is illustrated in FIG. 1, the mobile communication device 100 may include additional memory devices in other embodiments. Various data and software may be stored in the memory 116. For example, one or more operating systems, applications, programs, libraries, and drivers that make up the software stack executed by the processor 110 may reside in memory 116 during execution.

The data storage 118 may be embodied as any type of device or devices configured for the short-term or long-term storage of data. For example, the data storage 118 may include any one or more memory devices and circuits, memory cards, hard disk drives, solid-state drives, or other data storage devices

The communication circuitry 120 of the mobile communication device 100 may include any number of devices and circuitry for enabling communications between the mobile communication device 100 and one or more devices or networks as discussed in more detail below. The communication circuitry 120 may be configured to use any one or more, or combination thereof, communication protocols to communicate, such as, for example, a cellular communication protocol (e.g., Wideband Code Division Multiple Access (W-CDMA)), a wireless network communication protocol (e.g., Wi-Fi®, WiMAX), a wireless personal area network communication protocol (e.g., Bluetooth®), a wired network communication protocol (e.g., TCP/IP), and/or other communication protocols.

In some embodiments, the mobile communication device 100 may also include one or more peripheral devices 122. Such peripheral devices 122 may include any number of additional input/output devices, interface devices, and/or other peripheral devices. For example, in some embodiments, the peripheral devices 122 may include a display, touch screen, graphics circuitry, keyboard, speaker system, and/or other input/output devices, interface devices, and/or peripheral devices.

In an embodiment, before displaying the user login interface on the touch screen for a user to input a login password, the mobile communication device 100 may move a login input part selected from the user login interface. This way may move the login input part from a position for a previous user login to a new position for a new user login, and meanwhile, making a finger trace left on the touch screen for the previous user login meaningless. In an embodiment, the mobile communication device 100 may even randomly move the login input part each time when the user needs to input the password, in order to enhance security for user authentication.

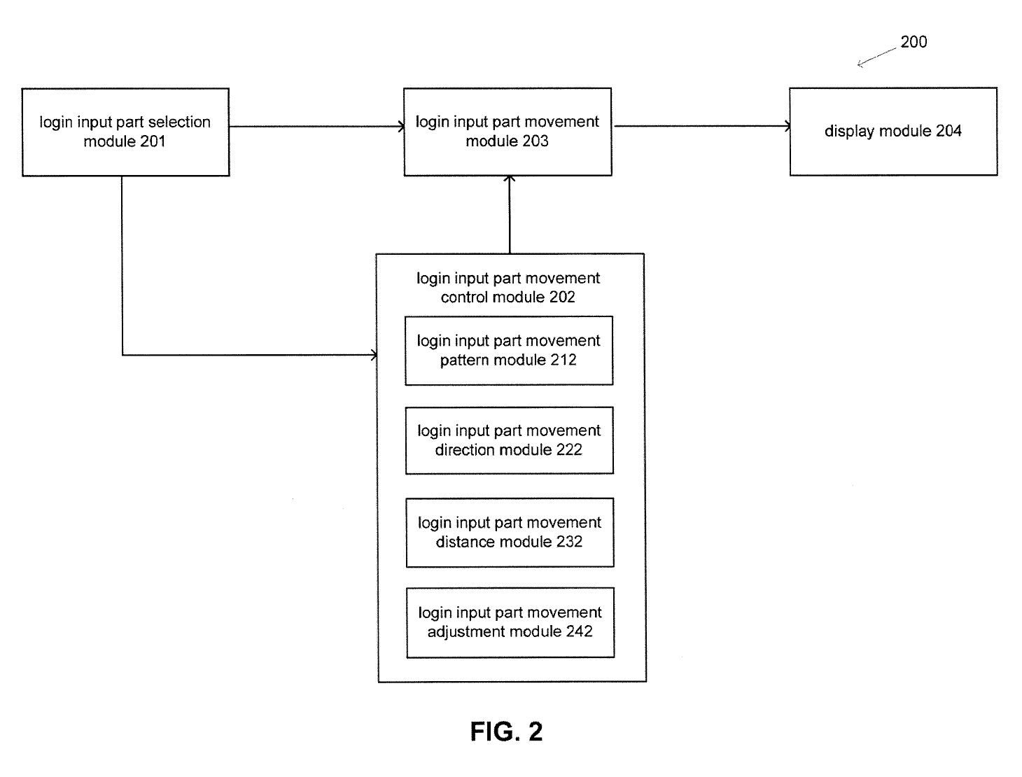

FIG. 2 illustrates an embodiment of an environment 200 for managing the user login interface, which is established by the mobile communication device 100. The illustrative environment 200 may include a login input part selection module 201, a login input part movement control module 202, a login input part movement module 203 and a display module 204. The various modules of the environment 200 may be embodied as hardware, software, firmware or a combination thereof. For example, any of the above-stated modules may be embodied as software instructions stored in a machine-readable medium of the mobile communication device 100, such as the memory 116.

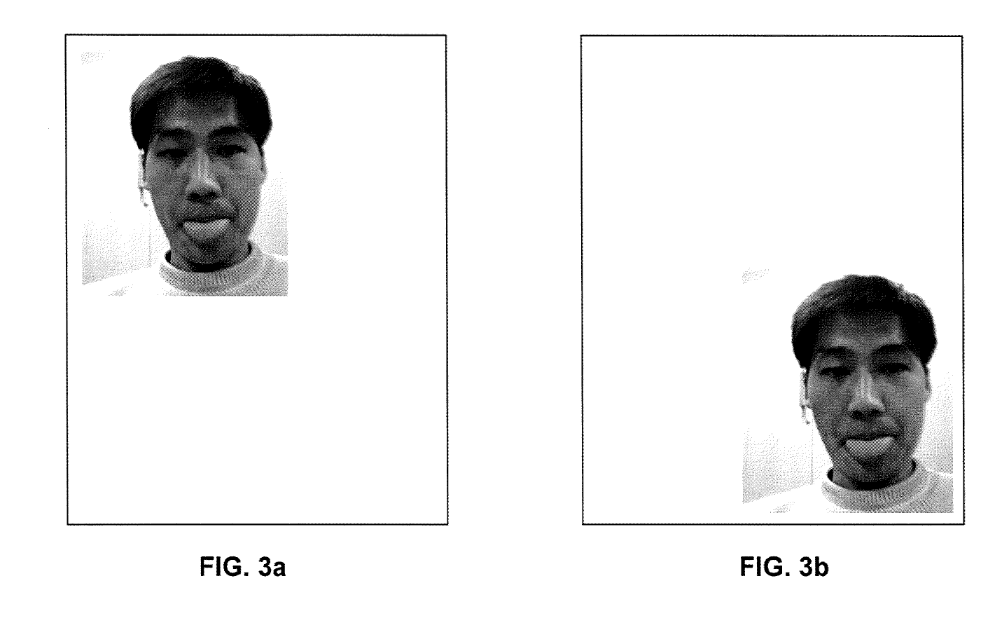

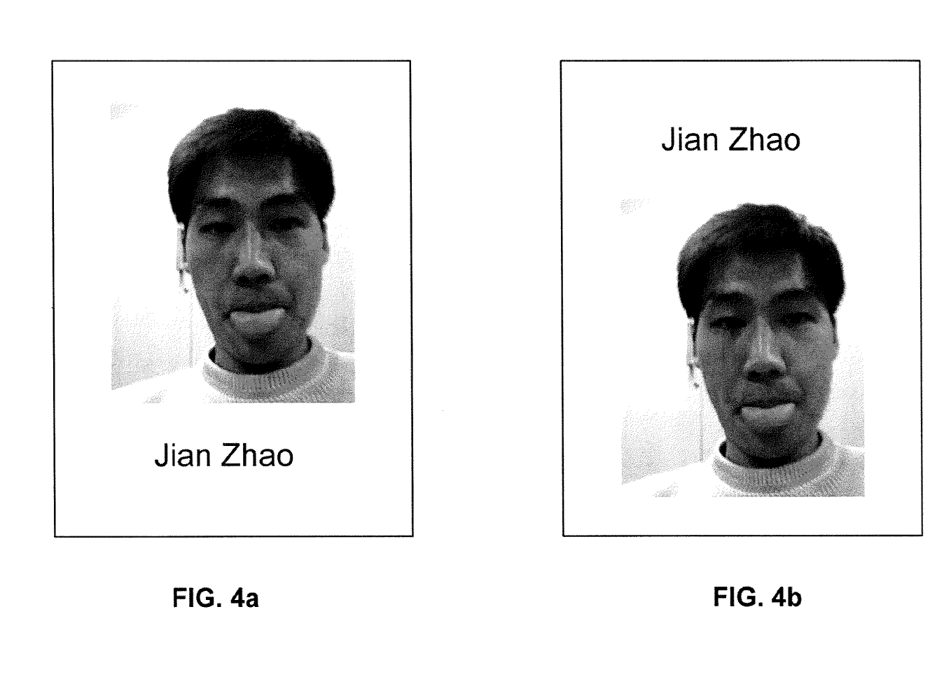

In an embodiment, the login input part selection part 201 may select the login input part from the user login interface to be displayed on the touch screen of the mobile communication device 100. The user login interface may refer to an interface displayed on the screen for the user to perform the login process. FIGS. 3a, 3b illustrate an embodiment of the user login interface, i.e., a picture of the user. FIGS. 4a, 4b illustrate another embodiment of the user login interface, i.e., the picture of the user and a picture of the user's name. The user may need to input the password, such as pointing at right eye, left eye, mouth and nose on the picture of the user and then pointing at letters “J” and “Z” on the picture of the user's name. The login input part may refer to a part or whole of the user login interface, into which the user may input the login password. In some embodiments, the login input part may comprise the whole of the user login interface, such as the picture of the user as shown in FIGS. 3a-3b. In such embodiments, the selection process in the login input part selection module 201 may be omitted. In other embodiments, the login input part may comprise the part of the user login interface, such as the picture of the user or the picture of the user's name as shown in FIGS. 4a-4b.

The login input part movement control module 202 may determine at least one factor related to a movement of the login input part selected by the login input part selection module 201. However, if the selection process in the login input part selection module 201 is omitted, the login input part may represent the whole of the user login interface. In an embodiment, the factor may comprise, without limitation, at least one from a group having a movement pattern, a movement direction and a movement distance, and/or others. It should be understood that the factor may comprise a different component from the above-stated. The login input part movement control module 202 may comprise a login input part movement pattern module 212, a login input part movement direction module 222, a login input part movement distance module 232, a login input part movement adjustment module 242, and/or others.

The login input part movement pattern module 212 may determine the movement pattern including, without limitation, at least one from a group having rotation, horizontal movement, vertical movement, diagonal movement, mirror movement and/or others. In an embodiment, the movement pattern may be randomly determined, and preferably, the two movement patterns determined for two successive user logins are different.

The login input part movement direction module 222 may determine the movement direction including, without limitation, left, right, up, down and/or others. In an embodiment, the movement direction may be randomly determined, and preferably, the two movement directions determined for two successive user logins are different.

The login input part movement distance module 232 may determine the movement distance. In an embodiment, the movement distance may be randomly determined, and preferably, the two movement distances determined for two successive user logins are different.

The login input part movement adjustment module 242 may adjust the factor(s) determined by one or more of the login input part movement pattern 212, login input part movement direction 222 and login input part movement distance 232, under a certain situation. For example, the login input part movement adjustment module 242 may adjust the factor(s) if the movement may cause the login input part out of the screen, and/or if the movement may cause the login input part overlapping with other part of the user login interface, especially, with another login input part, such as the picture of the user overlapping with the picture of the user's name.

In an embodiment, the login input part movement module 203 may move the login input part based on the factor(s) determined by the login input part movement control module 202. For example, the login input part movement module 203 may move the login input part for a previous user login, e.g., the picture of the user as shown in FIG. 3a, in the pattern of diagonal movement, in the direction of right and down, and in the distance about ½ the screen diagonal. FIG. 3b shows the result of the movement, which may be displayed on the screen of the mobile communication device 100 for a new user login.

For another example, the login input part movement module 203 may move one login input part for the previous user login, such as the picture of the user as shown in FIG. 4a, in the pattern of vertical movement, in the direction of down and in the distance about ⅕ the screen length, and meanwhile, moving another login input part for the previous user login, such as the picture of the user name as shown in FIG. 4b, in the pattern of vertical movement, in the direction of up and in the distance about ⅔ the screen length. FIG. 4b shows the result of the movement, which may be displayed on the screen of the mobile communication device 100 for the new user login.

The display module 204 may process the user login interface after the movement by the login input part movement module 203, for display on the screen of the mobile communication device 100, so that the user can input the login password.

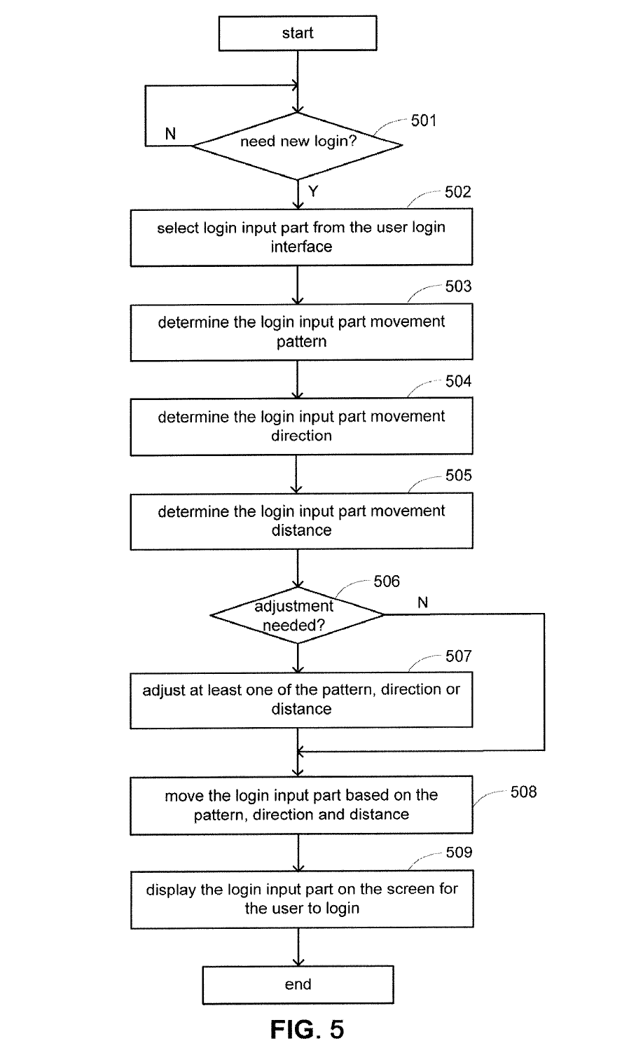

FIG. 5 illustrates an embodiment of a method of managing the user login interface.

In block 501, the mobile communication device 101 may determine whether the new user login is needed under a certain situation, such as booting the device 101, unlocking the device 101, running a program, and/or others. If needed, the login input part selection module 201 of the mobile communication device 100 or other device may select the login input part from the user login interface in block 502. However, as stated in the above, the selection process may be omitted and the login input part may represent the whole of the user login interface.

In blocks 503-505 the login input part movement control module 202 or other device may determine at least one factor related to the movement of the login input part from the position for the previous user login. In an embodiment, the factor may comprise, without limitation, at least one from a group having the movement pattern, the movement direction, the movement distance and/or others.

More specially, in block 503, the login input part movement pattern module 212 of the login input part movement control module 202 or other device may determine the movement pattern of the login input part. The movement pattern may comprise, without limitation, at least one from a group having rotation, horizontal movement, vertical movement, diagonal movement, mirror movement and/or others. In an embodiment, the movement direction may be randomly determined, and preferably, the two movement directions determined for two successive user logins are different.

In block 504, the login input part movement direction module 222 of the login input part movement control module 202 or other device may determine the movement direction of the login input part. The movement direction may comprise, without limitation, left, right, up, down and/or others. In an embodiment, the movement direction may be randomly determined, and preferably, the two movement directions determined for two successive user logins are different.

In block 505, the login input part movement distance module 232 of the login input part movement control module 202 or other device may determine the movement distance of the login input part. In an embodiment, the movement distance may be randomly determined, and preferably, the two movement distances determined for two successive user logins are different.

It should be understood that the process of blocks 503-505 may vary based on the factor(s) determined by the login input part movement control module 202.

In block 506, the login input part movement adjustment module 242 may determine whether the adjustment to the movement factor(s) determined in blocks 503-505 is needed. In some situations, the adjustment may be needed, for example, if the movement may cause the login input part out of the screen, and/or if the movement may cause the login input part overlapping with other part of the user login interface, especially, with another login input part, such as the picture of the user overlapping with the picture of the user's name.

If the adjustment is needed, then in block 507, the login input part movement adjustment module 242 or other device may adjust at least one of the factor(s), such as the movement pattern, the movement direction or the movement distance. In block 508, the login input part movement module 203 may move the login input part based on the factors determined by the login input part movement control module 202 or other device and in block 509, the display device 204 may display the login input part on the screen of the mobile communication device 100 for the new user login.

### EXAMPLES

Illustrative examples of the devices, systems, and methods disclosed herein are provided below. An embodiment of the devices, systems, and methods may include any one or more, and any combination of, the examples described below.

In one example, a mobile communication device may comprise a login input part movement control module to determine at least one factor related to a movement of a login input part from a position for a previous user login to a position for a new user login; a login input part movement module to move the login input part based on the at least one factor; and a display module to display the login input part after the movement for the new user login. Additionally, in any of the above examples, the at least one factor includes at least one from a factor group comprising movement pattern, movement direction and movement distance.

Additionally, in any of the above examples, the at least one factor is randomly determined by the login input part movement control module. Additionally, in any of the above examples, the login input part movement control module is further to adjust the movement of the login input part with regard to the at least one factor. Additionally, in any of the above examples, the mobile communication device may further comprise a login input part selection module to select the login input part from a user login interface to be displayed on the mobile communication device. Additionally, in any of the above examples, the movement pattern includes at least one from a pattern group comprising rotation, horizontal movement, vertical movement, diagonal movement and mirror movement.

In one example, a method may comprise determining at least one factor related to a movement of a login input part from a position for a previous user login to a position for a new user login; moving the login input part based on the at least one factor; and displaying the login input part after the movement for the new user login. Additionally, in any of the above examples, the at least one factor includes at least one from a factor group comprising movement pattern, movement direction and movement distance. Additionally, in any of the above examples, the at least one factor is randomly determined.

Additionally, in any of the above examples, the method may further comprise adjusting the movement of the login input part with regard to the at least one factor. Additionally, in any of the above examples, the method may further comprise selecting the login input part from a user login interface to be displayed on the mobile communication device. Additionally, in any of the above examples, the movement pattern may include at least one from a pattern group comprising rotation, horizontal movement, vertical movement, diagonal movement and mirror movement.

1-14. (canceled)

15. A mobile communication device, comprising:
a login input part movement control module to determine at least one factor related to a movement of a login input part from a position for a previous user login to a position for a new user login;
a login input part movement module to move the login input part based on the at least one factor; and
a display module to display the login input part after the movement for the new user login.

16. The mobile communication device of claim 15, wherein the at least one factor includes at least one from a factor group comprising movement pattern, movement direction and movement distance.

17. The mobile communication device of claim 16, wherein the movement pattern includes at least one from a pattern group comprising rotation, horizontal movement, vertical movement, diagonal movement and mirror movement.

18. The mobile communication device of claim 15, wherein the at least one factor is randomly determined by the login input part movement control module.

19. The mobile communication device of claim 15, wherein the login input part movement control module is further to adjust the movement of the login input part with regard to the at least one factor.

20. The mobile communication device of claim 15, further comprising a login input part selection module to select the login input part from a user login interface to be displayed on the mobile communication device.

21. A method, comprising:
determining at least one factor related to a movement of a login input part from a position for a previous user login to a position for a new user login;
moving the login input part based on the at least one factor; and
displaying the login input part after the movement for the new user login.

22. The method of claim 21, wherein the at least one factor includes at least one from a factor group comprising movement pattern, movement direction and movement distance.

23. The method of claim 22, wherein the movement pattern includes at least one from a pattern group comprising rotation, horizontal movement, vertical movement, diagonal movement and mirror movement.

24. The method of claim 21, wherein the at least one factor is randomly determined.

25. The method of claim 21, further comprising adjusting the movement of the login input part with regard to the at least one factor.

26. The method of claim 21, further comprising selecting the login input part from a user login interface to be displayed on a mobile communication device.

27. One or more machine readable storage media comprising a plurality of instructions that in response to being executed cause a mobile communication device to:
determine at least one factor related to a movement of a login input part from a position for a previous user login to a position for a new user login;
move the login input part based on the at least one factor; and
display the login input part after the movement for the new user login.

28. The machine readable media of claim 27, wherein the at least one factor includes at least one from a factor group comprising movement pattern, movement direction and movement distance.

29. The machine readable media of claim 28, wherein the movement pattern includes at least one from a pattern group comprising rotation, horizontal movement, vertical movement, diagonal movement and mirror movement.

30. The machine readable media of claim 27, wherein the at least one factor is randomly determined.

31. The machine readable media of claim 27, further comprising a plurality of instructions that in response to being executed cause the mobile communication device to adjust the movement of the login input part with regard to the at least one factor.

32. The method of claim 27, further comprising a plurality of instructions that in response to being executed cause the mobile communication device to select the login input part from a user login interface to be displayed on the mobile communication device.
